(19) United States
(12) Patent Application Publication
(10) Pub. No.: US 2025/0200326 A1
(43) Pub. Date: Jun. 19, 2025

(54) User Interfaces and Associated Data Processing Systems for Guided Event-Based Knowledge Graph Development and Utilization

(71) Applicant: Trippy Inc., Redwood City, CA (US)

(72) Inventor: Amirali Aliabadi, Woodside, CA (US)

(21) Appl. No.: 18/986,656

(22) Filed: Dec. 18, 2024

Related U.S. Application Data
(60) Provisional application No. 63/612,345, filed on Dec. 19, 2023.

(51) Int. Cl. G06N 3/042; G06N 3/082

(52) U.S. Cl. CPC G06N 3/042; G06N 3/082

(57) ABSTRACT

Methods and systems associated with user interfaces and data processing systems for information aggregation and dissemination are disclosed herein. A disclosed system includes an event-based knowledge graph. The set of nodes of the graph and the set of edges of the graph represent a set of event elements and connections within the set of event elements. The disclosed system also includes a set of dedicated content repositories for a set of events. The set of events are associated with the set of event elements. The system also includes a user interface. The user interface includes a set of user interface elements. The user interface elements are associated with event elements and provide navigation to the dedicated content repositories for events that are associated with the same event elements.

### CROSS REFERENCE TO RELATED APPLICATIONS

This application claims the benefit of U.S. Provisional Patent Application No. 63/612,345 as filed on Dec. 19, 2023, which is incorporated by reference herein in its entirety for all purposes.

### BACKGROUND

In the digital age, the news industry has undergone a seismic transformation. The rise of online platforms and social media has drastically increased access to information, making news more accessible than ever before. However, this transformation has come at a significant cost: it has led to a fragmented information landscape where content is scattered across countless sources, resulting in two critical challenges for consumers of news: broken trust and information overload.

Trust in the news has eroded as misinformation, bias, and sensationalism have become rampant. Social media platforms, while powerful tools for sharing information, often exacerbate this issue by prioritizing engagement over accuracy. Algorithms designed to maximize user retention inadvertently create “echo chambers,” exposing users primarily to perspectives that align with their existing beliefs. This deepens polarization, diminishes opportunities for balanced discourse, and erodes confidence in the media. The proliferation of platforms—ranging from social media to blogs and independent websites—further fragments the flow of information. Meanwhile, the rise of AI-generated content threatens to accelerate these trends, making it even harder for consumers to discern fact from fiction.

At the same time, the volume of information has grown exponentially, leading to a phenomenon commonly referred to as information overload. The relentless 24-hour news cycle, combined with the ubiquity of smartphones and social media, has resulted in a deluge of articles, tweets, and sensational headlines vying for attention. This flood of content leaves many consumers overwhelmed, fatigued, and uncertain about which sources to trust. Research shows that 64% of people doubt the credibility of the news they consume, and 66% report feeling worn out by the sheer volume of information.

This fragmentation has shattered the traditional centralized flow of information that once supported collective narratives and societal cohesion. The question arises: How can we rebuild trust, foster clarity, and organize information to better serve the public?

### SUMMARY

Methods and systems associated with user interfaces and data processing systems for information aggregation and dissemination are disclosed herein. More specifically, methods and systems associated with the computerized development and utilization of knowledge graphs are disclosed herein. These methods and systems include the development and utilization of an interactive event-based knowledge graph that structures and centralizes information around specific events. This approach counters fragmentation and broken trust by creating unique digital “homes” for each event, offering a collaborative and transparent space for users to engage with and contribute to the truth. By breaking down events into smaller, verifiable building blocks, these methods and systems enhance the utility of news, combat misinformation, and facilitate a more accurate and collaborative representation of events. Furthermore, these methods and systems include the utilization of a unique interface and language for the interactive event-based knowledge graph which counters information overload by not only making consumption of information faster, but by providing a relational framework to empowers users to map relationships and uncover insights that may have been missed before, with clarity and ease. By addressing the challenges of broken trust and information overload, the methods and systems disclosed herein create a more informed, collaborative, and cohesive digital landscape, and establish a foundational layer for the next generation of news consumption and engagement.

Specific embodiments of the invention disclosed herein address the challenges of echo chambers and information overload using systems and methods based on event-centric digital containers to organize and manage information. These containers function as a repository for the fundamental elements of news and information and form a set of organizational elements where each organizational element is dedicated to a specific event. Unlike traditional unstructured approaches, approaches using event-centric digital containers in accordance with this disclosure employ a shared, structured framework that provides clarity and focus to the information ecosystem. The systems and methods thereby facilitate collaborative engagement and verifiable contributions, reducing misinformation and fostering productive discourse.

Structured dialogue emerges as a critical tool in combating the harms of fragmented information. By breaking down complex issues into smaller, verifiable building blocks, users are empowered to focus on specific aspects of an event rather than being overwhelmed by the entire context. This approach enhances comprehension, promotes meaningful engagement, and reduces redundancy by centralizing discussions and content around unique, event-based digital containers. This structure not only alleviates information overload but also fosters critical thinking and a shared understanding of events. Accordingly, the organizational elements disclosed herein can function as structured headlines to facilitate structured dialogue. The structured headlines can refer to the event in an ordered manner using a tuple of event elements. The event elements thereby form the building blocks of the events. For example, a structured headline could be “Bjorn Gulden Hired to be the New CEO of Adidas” with the various components of that headline and additional data regarding the event (e.g., Bjorn Gulden, Hired As, and CEO of Adidas, Nov. 8, 2022, Berlin) being the tuple of event elements, and an associated container serving as a repository for media and content associated with the hiring of Bjorn Gulden as the CEO of Adidas. These event-specific elements, when combined, effectively create unique digital addresses that can precisely represent and reference specific events.

The event-centric digital containers can each be associated with a unique event. The event-centric digital containers can represent events that might have occurred in the past, are happening in the present, or could potentially occur in the future as theoretical scenarios. Regardless of when or if the event occurs, by basing the organizational elements on specific unique events, the system ensures that discussions regarding specific events are catalogued with a unique digital address that remains constant and can serve as a single repository for all the information associated with that specific and unique event.

Basing the organizational elements of the platform on events provides significant benefits both in terms of mitigating the harms of media sphere echo chambers and information overload. By providing a stable and unchanging reference point, these containers enable a more structured and focused discourse, allowing for a clearer understanding and analysis of news events. Furthermore, by providing a single reference point for a given event, users are encouraged to revisit, contribute to, and engage with specific events collaboratively. This approach creates a transparent and interactive ecosystem for news and information, where diverse perspectives can coexist within a unified structure. Users can navigate the system efficiently, gaining clarity and insight into complex topics while avoiding the pitfalls of fragmented and biased content. These methods and systems thereby have the potential to revolutionize our interaction with news and information, transforming it into a more engaging, informative, and collaborative experience. Moreover, the implementation of these digital containers offers a significant advantage in streamlining the overwhelming flow of news content. By encapsulating multiple articles and perspectives about a single event into one centralized location, these containers effectively reduce the redundancy inherent in the current news ecosystem. Users are relieved from the arduous task of navigating through a multitude of articles to form a well-rounded understanding of an event. Instead, they are presented with a carefully curated assemblage of pertinent content, encompassing a spectrum of perspectives, neatly organized within each container. Ultimately, this strategy aims to declutter the news and information landscape, making it more accessible and manageable for users, thereby enhancing the overall quality of news and information consumption in our digital world.

In specific embodiments, user interfaces and associated data processing systems for guided event-based knowledge graph development and utilization are provided. As used herein, the term knowledge graph refers to a computer-accessible data structure having nodes and edges where the nodes and edges serve as repositories of information and the edges represent relationships between nodes. As used herein, the term event-based knowledge graph refers to a graph in which events serve as the key organizational elements of the graph. A system that utilizes an event-based knowledge graph can exhibit the benefits described above in terms of encouraging structured discussion and preventing information overload.

In specific embodiments of the invention, a platform is provided to guide content-creators in the development of an event-based knowledge graph by constraining their description of events to specific tuples of event elements. The tuples of event elements can define the organizational elements of the system. Depending upon the characteristics of the systems, the tuples can take on various forms with each event element representing an aspect of the event such as the time it took place, the location of the event, an actor, a predicate, a direct object, and a myriad of other potential elements of the event. For example, an event could be the hiring of Bjorn Gulden as the CEO of Adidas and the event elements could be the actor “Bjorn Gulden,” the predicate “hired as”,” and the direct object “Adidas CEO.” By adhering to this structured approach, the associated system and methods disclosed herein ensure consistency and clarity in how events are represented and accessed.

The structured representation of events discussed above enables content consumers to explore the event-based knowledge graph with precision. Users can filter by specific event elements, such as actions by a particular individual or organization, or trends related to a company or topic. This granular navigation transforms the event-based knowledge graph into an intuitive and powerful tool for both contributors and consumers, enhancing its utility while maintaining a high level of organization. In keeping with the single event from the example in the prior paragraph, a content-consuming user will be able to filter the event-based knowledge graph rapidly in a single step to check every action taken by Bjorn Gulden over the past year, search for every person who has been hired to be the CEO of Adidas, or search for any other event that has had an impact on Adidas. By making the key to exploring the knowledge graph discretized portions of an event, the utility of the event-based knowledge graph for content-consuming users increases dramatically while placing minimal constraints on content-contributing users.

In specific embodiments, the platform can be based on organizational elements which are built from n-tuples of event elements. These organizational elements can be a form of the constraints mentioned above and can be used to organize the knowledge graph as it is being developed. The organizational elements can thereby define an event as an n-tuple of event elements of a specific type where the number “n” and the specific types of event elements serve as the constraints that set the structure of the event-based knowledge graph. The organization elements can be structured headlines with the event elements in the n-tuple of event elements serving as the building blocks of the structured headlines. In the example provided above, the organizational element could be a set of three event elements with the first event element being a subject, the second event element being a predicate, and the third event element being a direct object (i.e., the n-tuple is a triplet, and the types of event elements conform to a subject-predicate-object structure). The organizational elements can be presented to users to allow them to select specific event elements to navigate the event-based knowledge graph, and to select specific events to review content from, or add content to, a repository associated with those specific events.

There are significant benefits to the technical approaches disclosed herein. Using the approaches disclosed herein, discussions and additional information regarding specific events can be channeled to a specific place on a platform that is associated with an event-based knowledge graph entry for that specific event. Thereby, people will immediately begin to contribute information regarding that event to a specific place without having to rely on the organic agreement of disparate users regarding where that event should be discussed and how information regarding that event should be indexed. Furthermore, since the key organizational element of the event-based knowledge graph is the existence of a specific event, there is less of a chance that the core scaffolding of the event-based knowledge graph will be susceptible to misinformation. This is because, while people will always argue, as the subject of the argument tends towards the purely factual, there is less room for disagreement. Furthermore, even in extreme instances where the fog of conflict or the general noise of modern society makes it unclear whether an event happened or not, there is at least one place in which such a conversation about the event can occur in which people can express their skepticism and review rebuttals to their arguments regarding the existence of the event. In this sense, the core scaffolding of an event-based knowledge graph intentionally includes minimal information to combat the wide-ranging disagreements people can have over complex topics and the potential for misinformation to crowd out the useful information in the event-based knowledge graph.

In specific embodiments of the invention, a system is provided. The system comprises an event-based knowledge graph. The event-based knowledge graph comprises a set of nodes and a set of edges, where the set of nodes and the set of edges represent a set of event elements and connections within the set of event elements. The system further comprises a set of dedicated content repositories for a set of events, where the set of events are associated with the set of event elements. The system further comprises a user interface. The user interface comprises a set of user interface elements where the set of user interface elements are associated with the set of event elements and the set of user interface elements provide navigation to dedicated content repositories in the set of dedicated content repositories for events in the set of events that are associated with a same event element from the set of event elements.

In specific embodiments of the invention, a system is provided. The system comprises a list of organizational elements, where each organizational element comprises a tuple of event elements. The system further comprises a user interface input element that accepts a selection of an event element from the tuple of event elements, where the list of organizational elements is modified, in response to the selection of the event element, to include a set of tuples of event elements which all share the event element.

In specific embodiments, a system is provided. The system comprises an event-based knowledge graph for a set of events and an event definition engine, where the event definition engine allows for a definition of a new event for the event-based knowledge graph subject to a set of constraints, and where the set of constraints includes a constraint that an event be associated with a tuple of event elements having a fixed number of elements. The system further comprises a graph pruning engine, where the graph pruning engine deduplicates, in a deduplication, duplicate events from the event-based knowledge graph that refer to a single real-world event.

In specific embodiments of the inventions, a system is provided. The system comprises a user interface and a list of organizational elements presented on the user interface, where the organizational elements in the list of organizational elements comprise tuples of event elements, and where the event elements appear in multiple tuples of event elements in the list of organizational elements. The system further comprises a set of unique icons associated with the event elements in a one-to-one correspondence, where the unique icons in the set of unique icons are presented in the event elements in the tuples of event elements.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of an event-based knowledge graph that is in accordance with specific embodiments of the inventions disclosed herein.

FIG. 2 illustrates a block diagram of an event-based knowledge graph that is implemented as a hypergraph in accordance with specific embodiments of the inventions disclosed herein.

FIG. 3 illustrates a block diagram of a system for instantiating an event-based knowledge graph and for providing for the development, curation, and querying of the knowledge graph in accordance with specific embodiments of the inventions disclosed herein.

FIG. 4 illustrates a graph generation engine that can be used in accordance with specific embodiments of the inventions disclosed herein.

FIG. 5 illustrates a set of code snippets for querying an event-based knowledge graph in accordance with specific embodiments of the inventions disclosed herein.

FIG. 6 illustrates a series of screens of a user interface for navigating an event-based knowledge graph in accordance with specific embodiments of the inventions disclosed herein.

FIG. 7 illustrates a series of screens of a user interface for navigating an event-based knowledge graph via the selection of multiple event elements in accordance with specific embodiments of the inventions disclosed herein.

FIG. 8 illustrates a series of screens of a user interface for adding to an event-based knowledge graph in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different methods and systems for guided event-based knowledge graph development and utilization are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

### Event-Based Knowledge Graph

Systems and methods disclosed herein regard the development and curation of an event-based knowledge graph. The event-based knowledge graph can be a computer-accessible and computer-instantiated data structure storing information in the form of nodes and edges and accompanying information that is associated with those nodes and edges. The nodes and edges can serve as repositories of information regarding an element of the graph and the edges can represent relationships between those nodes. The event-based knowledge graph can be implemented as a hypergraph in which edges connect more than two nodes. The event-based knowledge graph can be implemented as a hypergraph in which edges can connect to other edges. The event-based knowledge graph can be implemented using edges, nodes, and higher order nodes where the higher order nodes are groupings of lower order nodes. The event-based knowledge graph can use events (e.g., real world events like a speech by a world leader or fictional events like a scene in a movie) as the key organizational structure of the graph. The event-based knowledge graph can be stored on a non-transitory computer-readable medium and can be developed, curated, and searched using the user interfaces disclosed herein. The structure of the event-based knowledge graph can impose constraints on the definition of events such that the graph can be easily navigated to understand relationships among the various events that are represented by the graph.

The event-based knowledge graph could take on various forms in different embodiments. The event-based knowledge graph can comprise a set of nodes and a set of edges. The set of nodes and edges can represent a set of events. The nodes of the graph could, either alone or in combination with the edges of the graph, define events subject to a set of constraints of the graph structure. The nodes of the graph could, either alone or in combination with the edges of the graph, define events and store information regarding the events such as the time the event occurred, who the participants in the event were, a location of the event, what occurred during the event, a duration of the event, and a body of artifacts regarding the event such as images, videos, commentary, and text information. The event-based knowledge graph could include a set of dedicated content repositories that are associated with the events defined by the graph in a one-to-one correspondence. The body of artifacts and other data regarding the events could be stored in the dedicated content repository for the event. The content repositories could serve as a centralized place to accept information from content-creators regarding the events defined by the event-based knowledge graph. The connect repositories could be associated with nodes, edges, or higher order nodes of the event-based knowledge graph.

The nodes and edges of the event-based knowledge graph can define a set of events in various ways. For example, individual nodes in the graph could represent single events and the event-based knowledge graph could define the events based on the data stored in association with those individual nodes and/or by the nodes connected to those individual nodes by the set of edges. Individual nodes that represent single events can be referred to herein as event nodes. Individual edges that represent single events can be referred to herein as event edges. Alternatively, or in combination, the set of nodes could represent a set of event elements and the edges of the graph could define events by linking sets of nodes that represent event elements of an event to an event node. Individual nodes that represent event elements can be referred to herein as event element nodes. The event element nodes can represent various aspects of an event such as the time the event occurred, the location, one or more entities involved in the event, an action, the duration of the event, and other aspects. In specific embodiments, the nodes of the graph will include both event nodes and event element nodes where the event nodes are defined by the event element nodes to which it is connected. As another example, edges of a hypergraph could represent events and the event elements connected by those edges could define the events. As another example, event nodes could be higher order nodes and event element nodes could be lower order nodes with the event nodes being defined by the lower order nodes that are within the scope of the higher order event node.

The event-based knowledge graph can be constrained in various ways to increase the utility of the graph. The event-based knowledge graph could be constraint by organizational elements such that the connectivity of the nodes and edges is constrained by a format and syntax of the organizational element. The organizational elements can define an event as an n-tuple of event elements of a specific type where the number “n” and the specific types of event elements serve as the constraints that set the structure of the event-based knowledge graph. Accordingly, the event-based knowledge graph may require event nodes to be connected by “n” edges to “n” event elements nodes. As another example, the event-based knowledge graph may require event edges to connect “n” event element nodes. As another example, higher order event elements may be required to be defined by “n” lower order event element nodes. Furthermore, the event element nodes may have specific types that match the types of event elements in the event-based knowledge graph and the event-based knowledge graph may require event nodes to be connected to a set of event element nodes having a specific set of types, may require event edges to connect a set of event element nodes having that specific set of types, or may require higher order event nodes to include a set of lower order event element nodes having that specific set of types.

The nodes and edges of the graph can be associated with various data elements. The nodes and edges can include information regarding the node and edge as a data element in the graph. For example, the nodes can include information on how many nodes it is connected to, how many times the node has been queried, how many times a content-consumer has indicated that they “like” or have some other impression of the event or event element represented by the node, when the node was created, etc. In specific embodiments in which the nodes represent different event elements, the nodes can be associated with information identifying which type of event element they represent (e.g., a direct object, a verb, a predicate, a location, a subject, etc.). In specific embodiments in which the graph includes edges of different types, the edges can be associated with information identifying which type of edge they represent (e.g., a direction of the edge, an edge that links event element nodes to define an event, an edge that links event element nodes to event nodes, an edge that links ancestor nodes, etc.) In specific embodiments of the invention, the nodes and edges in the graph can each be associated with a unique identifier. The nodes and edges can also be associated with one or more aliases. The nodes and edges can include information regarding the event or event element associated with the node. As a basic example, a node or edge can include an English language identifier of the event or event element. The nodes or edges can also include descriptors for the event or event element such as the time the event occurred, or information that defines the event element. If the event element were a person or other entity, the node could include information such as the place of birth, date of birth, occupation, full name, etc. If the event element were a verb, the node could include information such as synonyms for the verb as well as descriptors of the impact that the verb has on specific objects (e.g., the impact of a “break” on a vase, a sports record, and a peace treaty are different). As mentioned previously, the nodes and edges can also be associated with a dedicated content repository. The content can include image files, video files, audio files, or text files which may be relevant to the node. The metadata can be stored in the dedicated content repository mentioned above.

The data elements associated with the nodes and edges of the graph can be tags which are used for the development and maintenance of the knowledge graph. The tags can be added by automated systems that query and curate the graph. Alternatively, the tags can be added by users of the system as they navigate and consume the informational content associated with the graph. The tags can be used by automated systems such as the graph pruning engine and graph query engine described below. The tags can be used to identify potential duplicate events or events elements in the graph for distillation and pruning. The tags can be used to identify specific events or event elements as being locked from deletion by the graph pruning engine. The tags can also identify specific events or event elements as requiring manual review from an authorized user of the systems disclosed herein such as a subject matter expert. The tag can identify which type of subject matter expert is required for verifying the veracity or accuracy of the event, event element, or content associated therewith. Specific users of the system can be authorized as expert users in one or more subjects so that they are able to navigate the graph to find tags for subject matter they are authorized to verify. Upon verification, the tag associated with the event, event element, or content associated therewith could be changed to a “verified” tag.

The nodes of graph could be connected by different types of edges. For example, the nodes and edges of the graph could have nested associations such that certain edges or nodes had ancestor (e.g., parent or child) relationships between them, and the ancestor relationships could be represented in the graph by an alternative set of edges. The alternative set of edges could be in addition to a set of edges that link event elements for purposes of defining events in the knowledge graph. The different types of edges could each be used to query and navigate the knowledge graph. For example, a direct object event element associated with United States presidents could include 45 alternative edges to direct object event elements associated with each of the 45 United States presidents. Accordingly, any query for an event such as United States president+campaign speech+New Hampshire would flow to both Joe Biden and Donald Trump via alternative edge connections and draw events associated with each of their campaign speeches in New Hampshire through the main edges of the graph.

In specific embodiments, a set of event elements in an event-based knowledge graph includes a set of parent event elements and at least one set of child event elements. For example, the parent event element can be “United States President” and the child event elements could be a set of child event elements with each child event element being a different former or current president of the United States. The event-based knowledge graph can represent connections between the set of parent event elements and the set of child event elements. For example, alternative edges can link parent event elements in the set of parent event elements to child event elements in the set of child event elements even if the parent and child events do not define a single event on their own. The set of events can include a subset of events that are associated with the at least one set of child event elements. A set of user interface elements can include a set of parent event element user interface elements that provide navigation to dedicated content repositories in the set of dedicated content repositories associated with the subset of events. As such, searching based on the parent event elements will cause the system to retrieve the dedicated content repositories associated with children events of those parent events.

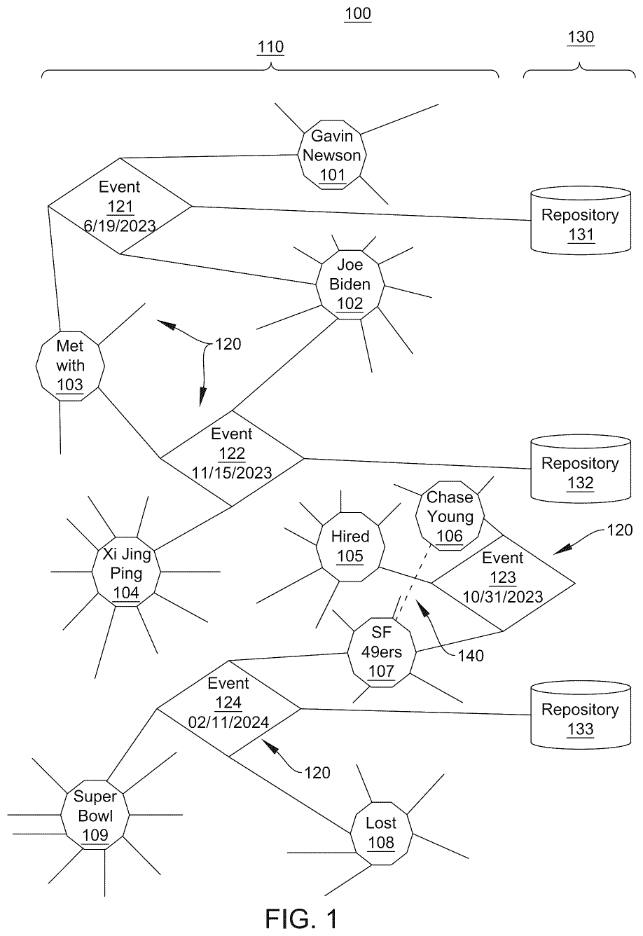

FIG. 1 illustrates a block diagram of an event-based knowledge graph 100 that is in accordance with specific embodiments of the invention disclosed herein. As illustrated, the event-based knowledge graph 100 comprises a set of nodes 110 and a set of edges which connect the nodes. The set of nodes 110 are the decagons in FIG. 1 and they represent a set of event elements which are instantiated by event element nodes 101-109. The set of edges represent connections within the set of event elements. For example, the “San Francisco 49ers” node 107 is connected to both the “Lost” event element 108 and the “Chase Yong” element 106 through different events. In the illustrated embodiment, the event element nodes 101-109 are connected via a second set of nodes 120. The second set of nodes 120 are the parallelograms in FIG. 1 and they represent a set of events which are instantiated by event nodes 121-124. The set of events are associated with the set of event elements as the event nodes 121-124 are connected to the event element nodes 101-109. The manner in which they are connected allows the event-based knowledge graph to define the events as the set of edges connect the set of nodes to the second set of nodes in such a way that they represent associations between the set of events and the set of event elements. For example, knowledge graph 100 defines a specific event with event node 121 which occurred on Jun. 19, 2023. The event node 121 is defined by its connections with the event element nodes Gavin Newsom 101, Joe Biden 102, and Met With 103 such that the specific event defined by the knowledge graph is a meeting between Gavin Newsom and Joe Biden on Jun. 19, 2023. Also illustrated is one example of an alternative edge 140 shown in dotted lines which defines Chase Young as a child node of the San Francisco 49ers. The alternative edges and main edges of the graph can have directionality stored as a property of the edges to represent the direction of ancestor relationships.

FIG. 1 provides an example of how, in specific embodiments, the events of an event-based knowledge graph can be subject to constraints that force the formatting and syntax of the events into a desired structure. For example, the event-based knowledge graph may be based on organizational elements that require an event to be defined by a fixed number of event elements. As another example, the event-based knowledge graph may be based on organizational elements that require an event to be defined by a set of event elements having specific types. As illustrated, event nodes 121, 122, and 124 include four interfaces which include three connections to event element nodes and one connection to a dedicated content repository (in specific embodiments, a dedicated repository of event node 123 may not be needed). The three connections set a fixed number of event elements that are required to define the event. As the event element nodes 110 can include data regarding what type of event element they are, the illustrated graph also puts a constraint on the type of event element that must be used to define an event with the illustrated case requiring a subject, a predicate, and a direct object. In specific embodiments of the invention, nodes can serve as more than one type of event element (e.g., event element node Joe Biden 102 may serve as both a subject and as a direct object).

In accordance with the example in FIG. 1 and related approaches, each event represented by the event-based knowledge graph is defined using a uniform syntax, making navigating the knowledge graph efficient and intuitive. With the limited set of nine event element nodes 101-109 in the example of FIG. 1 available, a content-consuming user could quickly search for every meeting of note that Gavin Newsom has had, every event associated with Xi Jing Ping, every team that has ever hired Chase Yong, every winner of the Super Bowl, and numerous other combinations simply by identifying event elements in the event graph. User interfaces that further highlight the utility of this aspect of the event-based knowledge graphs are disclosed below.

FIG. 1 also includes a set of dedicated content repositories 130 for the set of events. The dedicated content repositories are linked to the event nodes 120 of the knowledge graph in a one-to-one correspondence. In alternative embodiments, graph elements representing event elements will also have dedicated content repositories. To use FIG. 1 as an example, this would mean that both the event node representing the meeting between Joe Biden and Xi Jing Ping would have an associated dedicated content repository and the event elements representing Joe Biden and Xi Jung Ping would each also have an associated dedicated content repository. The dedicated content repositories can be quickly accessed with respect to the events they are connected to in the event-based knowledge graph. The dedicated content repositories can all be part of the same data structure but can be indexed independently with respect to the events to which they are associated. For example, a query of the graph that returned event node 121 could access repository 131, a query of the graph that returned event node 122 could access repository 132, and a query of the graph that returned event node 124 could access repository 133. When an event is first created, it may include a default content repository with basic information associated with the node such as the time or location of the event. However, in alternative embodiments, the information associated with the event node such as the time of the event could be separately stored, and a dedicated content repository could be created as soon as content that was not capable of being stored directly in association with the node was added by a content-creating user, such as video or image files being added in association with an event element node that is only formatted to store text data and other metadata.

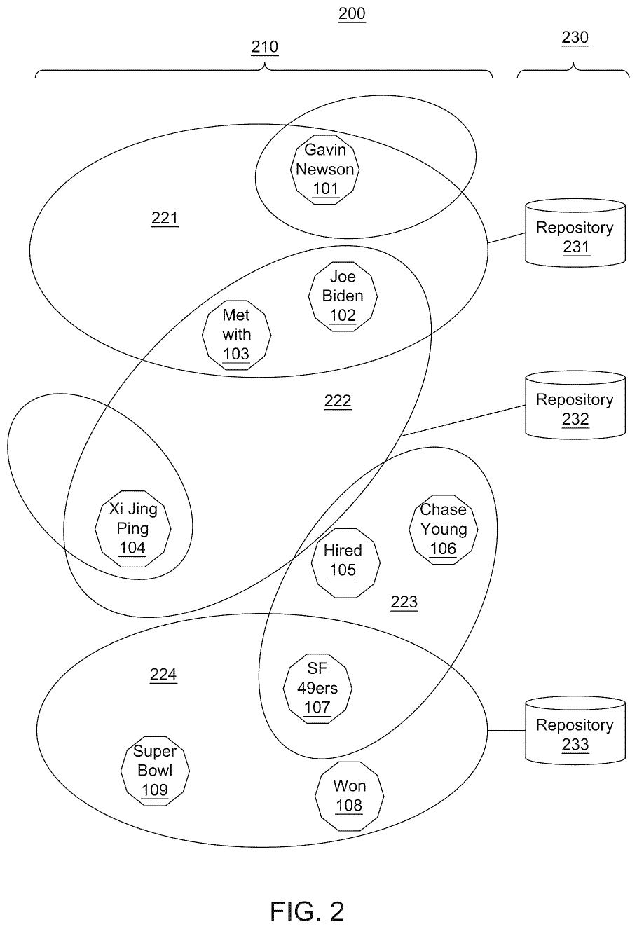

FIG. 2 illustrates a block diagram of an event-based knowledge graph 200 that is implemented as a hypergraph in accordance with specific embodiments of the invention disclosed herein. As illustrated, the event-based knowledge graph 200 comprises a set of nodes 210 and a set of edges which connect the nodes. In this case, the edges are hypergraph edges which link multiple nodes. The set of nodes 210 are the decagons in FIG. 2 and they represent the same set of event elements from FIG. 1 which are instantiated by event element nodes 101-109. The set of event edges are hypergraph edges that connect multiple nodes within the set of event elements nodes. For example, the “San Francisco 49ers” node 107 is connected to both the “Lost” event element 108 and the “Chase Yong” element 106 through hypergraph event edge 223 and hypergraph event edge 224. In the illustrated embodiment, the event element nodes 101-109 are connected via a set of hypergraph event edges 221-224. The hypergraph event edges are the ovals in FIG. 2 and they represent a set of events which are instantiated by the hypergraph event edges 221-224. The set of events are associated with the set of event elements as the hypergraph event edges 221-224 connected the event element nodes 101-109. The manner in which the event elements are connected allows the event-based knowledge graph to define the events as the set of hypergraph event edges connect the event element nodes that define the events. For example, knowledge graph 200 defines a specific event with hypergraph event edge 221. The hypergraph event edge 221 is defined by the event element nodes Gavin Newsom 101, Joe Biden 102, and Met With 103, which are all connected by hypergraph event edge 221, such that the specific event defined by the knowledge graph is a meeting between Gavin Newsom and Joe Biden. The hypergraph event edges can be associated with metadata that is specific to the edge such as the date of the event and other aspects or the event. In specific embodiments, dates or specific time stamps can also be event element nodes that are linked together by the hypergraph event edges and that define a time at which an event occurred. In these embodiments, the syntax of the event graph may require that each hypergraph event edge connect to at least one date or specific time event element.

FIG. 2 also includes a set of dedicated content repositories 230 for the set of events. The dedicated content repositories are linked to the hypergraph event edges 221-224 of the knowledge graph in a one-to-one correspondence. The dedicated content repositories can be quickly accessed with respect to the events they are connected to in the event-based knowledge graph. The dedicated content repositories can all be part of the same data structure but can be indexed independently with respect to the events to which they are associated. For example, a query of the graph that returned hypergraph event edge 221 could access repository 231, a query of the graph that returned hypergraph event edge 222 could access repository 232, and a query of the graph that returned hypergraph event edge 224 could access repository 233. When an event is first created, it may include a default content repository with basic information associated with the edge such as the time of the event. However, in alternative embodiments, the information associated with the event edge such as the time or location of the event could be separately stored, and a dedicated content repository could be created as soon as content that was not capable of being stored directly in association with the node was added by a content-creating user such as video or image files being added in association with an event element node that is only formatted to store text data and other metadata.

The content repositories mentioned above can take on varying characteristics in different embodiments of the invention. The content repositories can include text, images, videos, sound files, and any other content that can be used to describe an event. The content can be automatically generated from external content for inclusion in the content repositories using the approaches disclosed herein. The content repositories can be manually generated by users uploading content to the content repositories using a wiki paradigm. The content repositories can include areas for comments or discussions regarding the event in question and the ability of certain comments or commentary to be emphasized over others based on the amount of impressions the comments or commentary has received from other users. The comments can be provided in text, audio, or video form and can be submitted in text, audio, or video form. The content repositories can include summaries that are generated by the automated systems disclosed herein such as generative artificial intelligence models which consume the content in the repository and generate either a text, video, or mixed media summary of the content in the repository. The summaries can include a video or text summary of voice chat conversations that have occurred regarding the event. The video or text summaries of the voice chat conversations can be generated by generative artificial intelligence models. The summary can include commentary on the reliability of the sources that provided the content. The content repository can include a system for ranking content based on the expertise or other measure of reliability for the source of the information. The ranking of the content can be used to display the content more prominently or by displaying the ranking to users so that they can have an idea of how reliable and accurate ethe content is. The ranking of content can be based on a reputation system for the contributors. For example, a user can obtain a higher ranking in the system by providing content that is not often disputed by other users, that obtains favorable impressions, or that is verified automatically against other content contributed by other users with positive reputations or other verified external sources of information.

### Event Graph and Associated Data Processing System Instantiaton

The event-based knowledge graph can be computer-instantiated and computer-accessible. The data that represents the nodes and edges of the graph, as well as the information stored in association with the nodes and edges, can be stored in a non-transitory computer-readable medium. The event-based knowledge graph can have additional nodes or edges added using an event definition engine, can have additional associated content generated using a graph generation engine, and can be deduplicated using a graph pruning engine, and can be queried using a graph query engine. These engines can be collections of scripts and libraries that are instantiated using one or more processors and that are configured to conduct the actions described below in the sections dedicated to these engines. The engines can include APIs or callable functions to integrate them with other components of the system.

The event-based knowledge graph can be built on the Resource Description Framework (RDF) data model. The event-based knowledge graph can be stored in a specialized database system to store, query, and administer RDF data. The RDF data model can provide the infrastructure to store, index, and query the event-based knowledge graph. As applied to an event-based knowledge graph, the RDF models relationships between linked data and represents facts in the form of binary relationships, in particular (subject, predicate, object) (SPO) triples, where subject and object are entities and predicates are the relation between them. Benefits of the RDF include rapid search and retrieval of associated event elements (e.g., n-tuples), disambiguation and deduplication of different events represented by the event-based knowledge graph that are associated with the same real-world events, and the semantic representation of associated event elements.

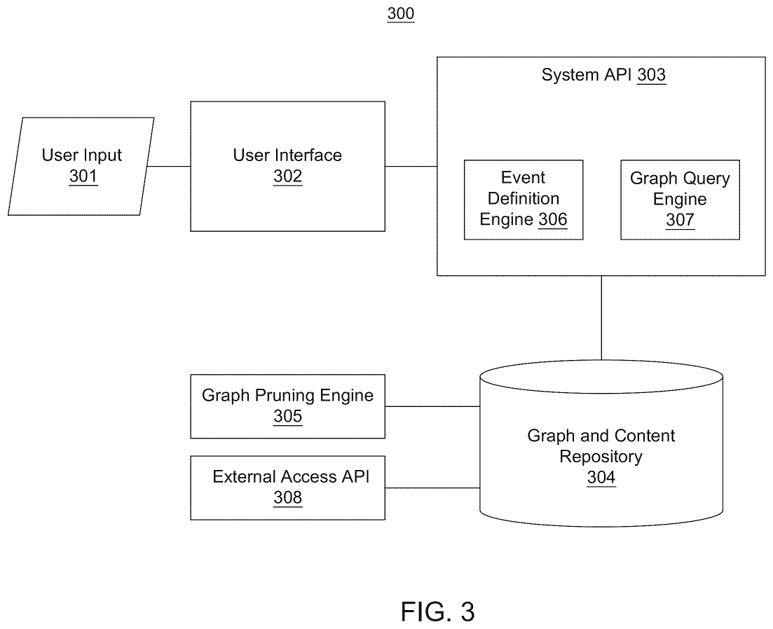

FIG. 3 illustrates a block diagram of a system 300 for instantiating an event-based knowledge graph and for providing for the development, curation, and querying of the knowledge graph in accordance with the approaches disclosed herein. System 300 receives user input 301 on user interface 302. User interface 302 receives user input 301 via a touch screen, an eye tracker, a microphone, a keyboard and mouse, a gesture recognition device, encephalographic interface, or any other user interface element. User interface 302 can be instantiated on a client device such as a smartphone, laptop, pair of VR/AR goggles, wearable, or any other client device. The user interface can accept user inputs to add to the event-based knowledge graph from a content-producing user or inputs to query the event-based knowledge graph from a content-consuming user.

System 300 includes a system API 303 which can be instantiated on a server device. System API 303 can include an interface with user interface 302 using standard API calls over a network such as the Internet. System API 303 can include an interface with graph and content repository 304 using standard API calls. System API 303, graph and content repository 304, and graph pruning engine 305 can be instantiated by one or more server computers and operate as a back-end processing system for user interface 302. System API 303 can include an event definition engine 306 to allow a content-creating user to add events to the event-based knowledge graph stored by graph and content repository 304. While not pictured, system API 303 can also include an engine to allow content-creators to add content to the dedicated content repositories in graph and content repository 304 in the form of anything from files to individual comments. System API 303 can also include a graph query engine 307 to allow a content-consuming user to query the event-based knowledge graph and retrieve information from the graph and content repository 304.

Graph and content repository 304 can include computer-readable media for storing the event-based knowledge graph and the associated dedicated content repositories. Graph and content repository 304 can utilize an RDF data model to store the event-based knowledge graph and can receive RDF queries from graph query engine 307 to find the information requested by graph query engine 307.

System 300 also includes a graph pruning engine 305. The graph pruning engine can be designed to deduplicate events in the event-based knowledge graph that refer to the same event. The graph pruning engine can be configured to modify associations between content repositories and the set of events, and event elements, represented by the event-based knowledge graph. For example, the graph pruning engine can be configured to modify what content repositories are associated with which nodes in the graph. As such, the graph pruning engine can be a collection of scripts and libraries that are provided with edit access to the data model that instantiates the event-based knowledge graph. By changing these associations, future graph queries directed to navigating the event graph towards an associated content repository will be directed to the newly associated node instead of a previously associated node.

The graph pruning engine 305 can be configured to detect duplicate events or be provided with information identifying duplicate events for the graph pruning engine 305 to take action upon by eliminating the duplicates. The graph pruning engine can receive information from the system API 303 via the graph and content repository regarding user feedback as to which events may be duplicative. The graph pruning engine can include artificial intelligence systems such as large language models to obtain an understanding of the content associated with specific events to determine if they are indeed related to the same underlying real-world event.

In specific embodiments, system 300 can include a graph development engine in place of graph pruning engine 305. The graph development engine can be used to generate event elements and events for the event-based knowledge graph, generate content for the associated content repositories, and conduct maintenance operations on the event-based knowledge graph and associated content repositories. The graph development engine can include artificial intelligence systems such as large language models to obtain an understating of the content associated with an event, to optimally add the event to the knowledge graph, and to generate the content in the content repository for the event.

In specific embodiments, the graph development engine can be configured to conduct A-B testing for both the addition of events and event elements to the event-based knowledge graph and for the addition of content to the content repositories. The A-B testing can meet the constraints of the knowledge graph using different formulations when adding a particular event to the graph and can monitor the level of engagement and ease of navigation for each formulation before selecting that formulation as the one to utilize for the graph. For example, the graph development engine could determine that a formulation of an event using the event elements “De′Vondre Campell”; “Suspended”; “NFL Football” is not getting as much traction and interest as “De′Vondre Campell”; “Bails On”; “49ers” and could then keep the formulation that was getting more engagement while pruning the alternatives.

In specific embodiments, a graph development engine or graph pruning engine can serve to prune the event-based knowledge graph after a duplicate event is detected in that it can merge separate content repositories for a given event when removing the duplicate event. The graph development engine or graph pruning engine can include an artificial intelligence system such as a large language model to review the content of the two separate repositories and generate a new entry using the content from both repositories.

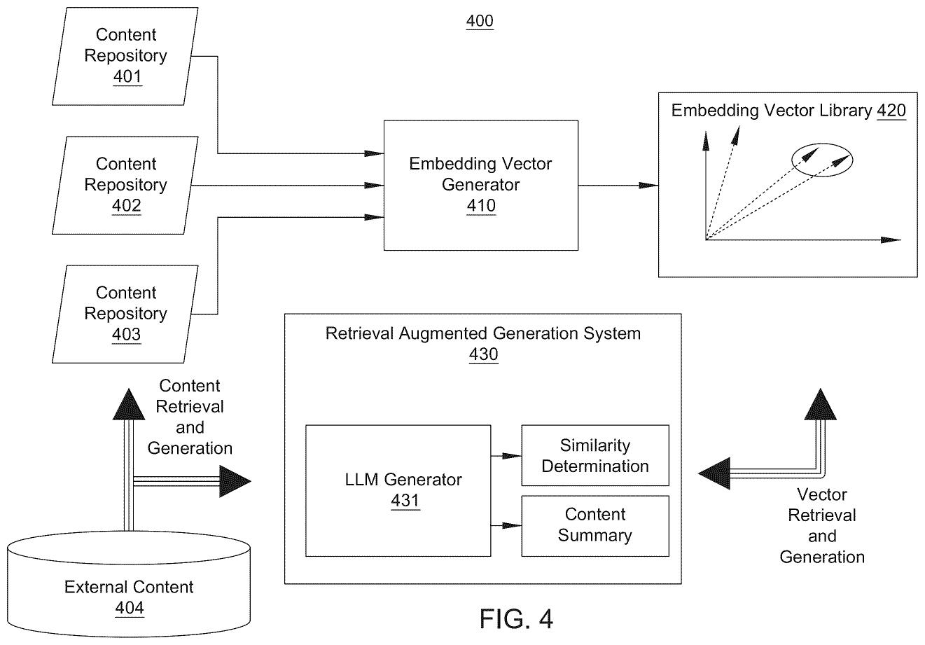

FIG. 4 illustrates a graph development engine 400 that can be used in specific embodiments of the systems and methods disclosed herein. Graph development engine 400 includes access to content repositories 401, 402, and 403 which are content repositories associated with specific nodes or edges of an event-based knowledge graph that is being generated by graph development engine 400. Graph development engine 400 also includes access to external content 404 which could be internet accessible content that describes aspects of events that can be added to the event-based knowledge graph. Graph development engine 400 also includes an embedding vector generator 410, an embedding vector library 420, and a retrieval augmented generation (RAG) system 430.

Graph development engine 400 can be used to build and maintain an event-based knowledge graph and associated content repositories. The content for the content repositories can be generated based on content from an external source. The content for the content repositories can be generated by merging the content from multiple content repositories that are already associated with the event-based knowledge graph. The content for the content repositories can be summaries of the content that is already in a content repository to make the content associated with each event easier to digest. The content can be generated using a transformer such as OpenAI GPT or Hugging Face Transformers. RAG system 430 can obtain external content 404 and use a system such as an LLM generator 431 to produce event definitions and content summaries to store in content repositories in association with those events. For example, a user could identify their account from an external platform such as Twitter and RAG system 430 could obtain all of the content from that account and use LLM generator 431 to produce a set of events defined by all of that content, or process that content to create new content describing events that are already in the event-based knowledge graph for storage in a content repository. RAG system 430 could also obtain content from content repository 401 to produce a summary of that content and then write back the summary to content repository 401. RAG system 430 could also obtain content from content repositories 401 and 402, and in response to a determination that the content repositories should be merged, generate new combined content and write it back to content repository 401 or 402.

Graph development engine 400 can be used to help prune the event-based knowledge graph by identifying similarities between events and eliminating specific events from the graph. In specific embodiments, events can be analyzed for similarities by reviewing the event elements of the graph using a large language model or other artificial intelligence system. In the illustrated embodiment, similarities are identified using embedding vectors for the content associated with the event. In a simple case in which no content has yet been added to the content repository, the content associated with the event can be the names of the event elements alone (e.g., Brazil-Wins-World Cup 2026). Embedding vector generator 410 can generate embedding vectors for the content in the content repositories of the system and store them in embedding vector library 420. The embedding vectors in embedding vector library 420 can be indexes of the events associated with the content repositories. RAG system 430 can then use tools such as FAISS, Elasticsearch, and Weaviate to search for embedding vectors that reach a threshold level of similarity (e.g., cosine similarity below a threshold scalar value) and retrieve the content associated with those vectors from the content repositories to then condense the content into a single content repository. RAG system 430 is shown as also generating embedding vectors in that it can produce content for a content repository which is then translated into a vector by embedding vector 410. The embedding vector generator 410 can be trained to generate vectors that are close when an objective observer would consider the described events to be identical or so related that it would be redundant to refer to them as separate events. In alternative embodiments, the embedding vector generator 410 can be trained to generate vectors that are spread out to maximize the variety of events that are described without cluttering the event-based knowledge graph to the point where search and navigation times appear to be adversely impacted. In specific embodiments, search times and ease of navigation can be part of a loss function that is used to train embedding vector generator 410.

System 300 also includes external access API 308 for providing direct access to graph and content repository 304. External access API 308 can be used to provide manual command line level instructions for modifying the structure of the event-based knowledge graph, the content of the content repositories, and the associations between the graph and repositories. The external access API 308 can allow for accessing and manipulating the knowledge graph and associated content repositories and act as a bridge between external users and the system's underlying data. The API can provide a set of endpoints that support secure authentication and authorization to ensure appropriate access control. Through these endpoints, users can query the event-based knowledge graph using semantic languages like SPARQL, retrieve structured data, and perform operations such as adding, updating, or deleting nodes and relationships. Similarly, external access API 308 can enable interaction with content repositories by allowing external users to search, upload, update, or retrieve documents and associated metadata. External access API 308 can employ REST or GraphQL for ease of integration, support batch processing for efficiency, and include safeguards like versioning and validation to maintain data integrity.

### User Interface and Data Processing System for Generating and Navigating the Event Graph

Systems and methods disclosed herein regard approaches for building and navigating an event-based knowledge graph. The systems and methods can include user interface elements and data processing systems. The user interface can be user interface 302. The data processing systems can include graph query engine 307. The user interfaces and data processing systems can be formulated to operate in tandem with the event-based knowledge graphs having the characteristics described in the previous sections. Generating an event-based knowledge graph can include adding events or event elements to the event-based knowledge graph, subject to any constraints based on the definition of events or event elements, and adding content to the content repositories associated with the events or event elements. Navigating an event-based knowledge graph can include querying the event-based knowledge graph to find events of interest to the user and accessing content stored in association with those events.

The user interface can take on various forms. The user interface can be instantiated in a client device and be designed to accept selections of specific events or event elements of interest to the user. Events can be presented to the user in the form of organizational elements. The organizational elements can be presented to the user in graphical form such as a set of related icons that provide a pictorial representation of the event. In situations in which a user interface element associated with an event is selected, the data processing system can retrieve content from the dedicated content repository associated with that event and present the stored information to the user. Event elements can be presented to the user on the user interface in the form of user interface elements that form a part of the organizational elements mentioned previously such as one of the related icons mentioned above. As another method for navigating the event-based knowledge graph, in situations in which a user interface element associated with an event element is selected, the data processing system can formulate a query for the database for those event elements. As used herein, the term user interface element refers to both a known or perceptible prompt for a user (e.g., a graphical icon on a touch screen) and the system that is capable of detecting the input from the user (e.g., a touch screen, touch controller, analog front end, and associated software for determining the location of the touch relative to that graphical icon).

The user interface can be configured to accept selections of event elements in various ways. The graph can be queried using a user interface that presents lists of organizational elements to a content-consuming user where each organizational element comprises a tuple of event elements. The organizational element can represent an event. The tuple of event elements can match the tuple of event elements that are required to define an event in the event graph as described above. The organizational element can be represented by one or more user interface elements. For example, the organizational element can be represented by a collection of user interface elements where each user interface element represents a specific event element and where the user interface elements are presented in a manner which indicates the event elements which they represent are related and form a part of the definition of the event.

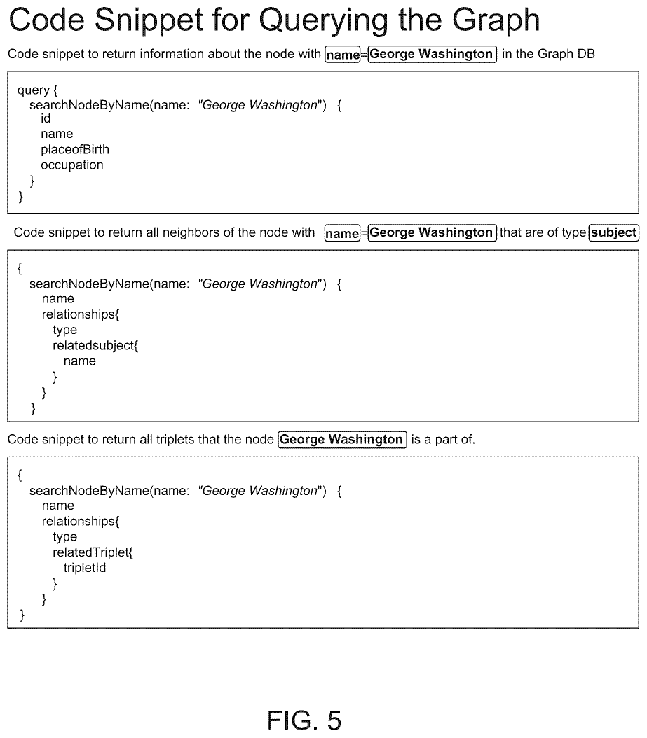

The data processing systems that allow a user to navigate the event-based knowledge graph in combination with the user interface can include a graph query engine. The graph query engine can have the general characteristics of graph query engine 307. The graph query engine can accept selections of user interface elements from the user interface in order to formulate a query for the graph. The graph query engine can be instantiated by source code in the form of Java, C, R, or any procedural programming language and can run on a server that offers availability to the graph to client devices. The graph query engine can format the user interface element selections into an RDF query for a database structure that stores the graph. For example, the user interface elements can identify a selection of one or more event elements, and the graph query engine can formulate a query to return all events that are associated with the selected event elements. Code snippets that can be generated by the graph query engine and run against the RDF database structure are provided in FIG. 5. In the illustrated case, the organizational elements are referred to as triplets as the events are defined by 3-tuples of event elements.

In specific embodiments, the organizational elements can be presented to a user using a design language that makes them both engaging and easy to interface with. The organizational elements can be presented in a way to make them easy to digest and distinguish from other organizational elements. The icons for the organizational elements can include a set of icons for the event elements which are separated but grouped together to the obvious exclusion of other organizational elements. For example, a tuple of event elements could be presented as a row of spaced cards in a list where the list can be scrolled up or down to review different tuples of event elements. Further to this example, the edges of the event elements on the outside of the row can be rounded while all the other edges of the event elements are squared to enhance the appearance of the row of spaced cards as a discrete and connected element while keeping the individual cards separate.

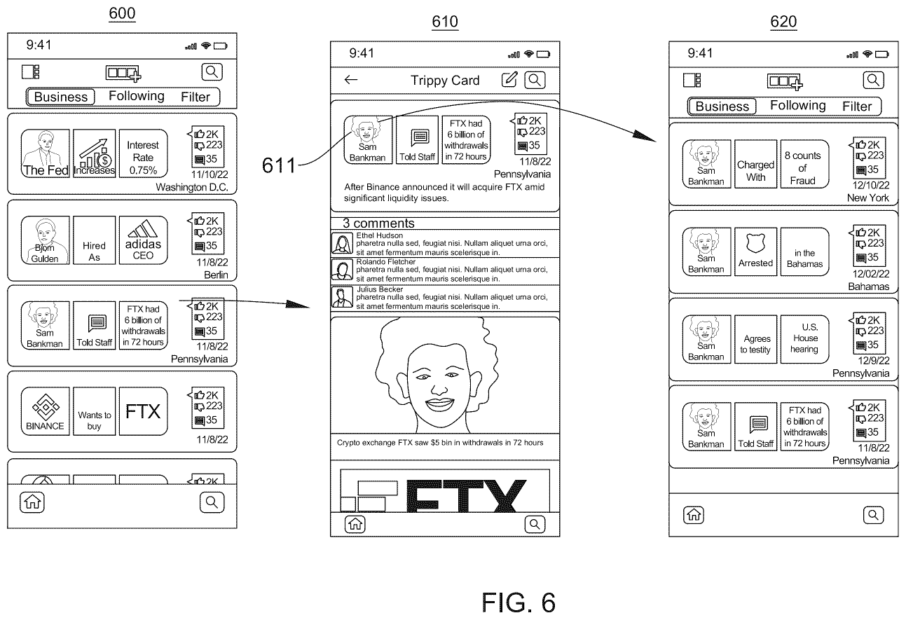

FIG. 6 illustrates a first screen of a user interface 600 which includes a list of organizational elements in the form of 3-tuples of event elements. The organizational elements are defined by three icons representing the event elements. The elements are spaced apart but are presented as being part of a complete whole because the outside corners of the two edge icons are rounded. Also, the organizational element is presented in a line and is placed on a shaded area which is spaced apparat from the next organizational element in the list. The organizational element is presented in the list with a location and time for the event associated with the organizational element. The organizational element is also presented with a summary of the impressions of the event in the form of the number of likes, dislikes, and comments that have been added by users with respect to the event. The list can be presented in various formats including chronological order, can be scrolled through, and can be filtered using custom filters or broad built in filters such as the “business” or “following” filters shown at the top of the list. The following filters can allow a user to filter their list to only show organizational elements that are related to specific entities, only show organizational elements that are generated by content-creating users they are following or include event elements they have chosen to follow (i.e., any event with “Adidas” as the subject or direct object should be included in a following list).

In specific embodiments, users will be able to filter the event-based knowledge graph based on location. For example, a user may be provided with the ability to enter a location either by providing an address or selecting a point on a map. The system may be designed to display all events that are associated with the selected location. In an alternative embodiment, a user may be provided with the ability to select a “my location” user interface element and, if the system is provided with location data for a client device on which that user interface element was selected, display all events that are associated with the location of the client device. The associated functionality would be helpful for people interested in finding out about event that happened near them such as a loud noise or a live event that they are attending, or in doing historical or other touristic research regarding their surroundings while traveling.

In the specific example of FIGS. 6-8 the user interface elements for the organizational elements in the user interface can comprise a set of cards representing an event where each card represents an event element in a tuple of event elements and can be referred to as Trippy Cards because they include a 3-tuple (or triplet) of event elements and because the name of the application from which the screens are taken is called Trippy. However, the term organizational element will be used throughout this discussion of FIGS. 6-8 as it is a more general term than Trippy Cards. Throughout the discussion of FIGS. 6-8, an entity such as an event, an organizational element, or an event element can be described as being “selected” when a user interface element associated therewith receives a selection input from a user.

FIG. 6 illustrates a series of screens of a user interface for navigating an event-based knowledge graph in accordance with specific embodiments of the inventions disclosed herein. The series of screens includes the first screen of the user interface 600 which shows a list of user interface elements for different organizational elements. The second screen of the user interface 610 shows the resulting screen that is provided when an organizational element is selected from the list. The resulting screen can be an event-specific page that pulls content from the content repository for the event that is defined by the organizational element that was selected. As illustrated, the event-specific page can include a user interface element for the organizational element at the top and can include comments and other content in a scrollable interface below that. The event-specific page can also be used by users to add additional content such as files or comments. In the second screen of the user interface 610, the ability to add content is provided by the press of a button with an icon showing a pencil on a paper. The screen also includes a search widget which can allow users to search within the event-specific page for desired content.

In specific embodiments of the invention, icons can be added to organizational elements or user interface elements to provide information to users regarding the status of an event or event element. For example, an icon can be added to an organizational element and displayed to a user to indicate that an event is happening live (e.g., the Trippy cards Taylor Swift—Performing—So-Fi Areana could have an animated icon in the upper right corner of the set of cards where the icon is moving or flashing to indicate that the performance is ongoing). As another example, an icon could be added to indicate that an event or event element, or the associated content, was currently disputed (e.g., the veracity or accuracy of claims regarding the event or content associated with the event could be called into question by one or more users or by automated systems monitoring the content of the graph). As another example, an icon could be added to indicate that a particular event or associated content had been fact checked either by validated expert users of the system or by automated systems provided by the system itself. In specific embodiments, different icons will appear for different users. For example, experts that are verified for confirming the veracity of claims in certain fields could see icons indicating that their input is required for confirming the veracity of specific events, event elements, or associated content.

In specific embodiments of the invention, the user interface elements for the event elements in the organizational elements can be utilized to navigate the event-based knowledge graph. To this end, the user interface elements of the organizational element can include a user interface input element that accepts a selection of an event element from a tuple of event elements. Each event element can be associated with a user interface input element that can receive a selection of the event element. Selecting that event element can then filter the list of presented organizational elements to a list of presented organizational elements that share the selected event element. In specific embodiments of the invention, multiple event elements (e.g., two event elements) can be selected at the same time using a separate gesture such as a swipe or two long presses on the event elements. The selection of multiple event elements can then filter the list of presented organizational elements to a list of presented organizational elements that share all the selected event elements.

In specific embodiments, a user interface can display an organizational element to a user with one or more event elements missing in order to provide a trivia game for a user. The user interface could display a multiple choice option for the missing elements and provide the user with feedback on whether they were correct or not. The organizational element could relate to the most popular event from the day prior, for all time, or since the user had checked the system (e.g., Taylor Swift—Dating—? would be presented to a user the day after news broke regarding Taylor's dating life). The trivia game would thereby be an engaging way for people to catch up on the most important events, from their perspective, that had happened in a given time frame. The trivia questions could be curated to relate to topics that a user was interested in and followed closely, or to encourage exploration into other segments of the event-based knowledge graph that a given user might not otherwise have considered engaging with.

The second screen of the user interface 610 includes a user interface element 611 that can accept a selection of the event element “Sam Bankman.” As illustrated, in response to the selection of that event element via an input to the user interface element 611, a list of organizational elements presented to the user can be modified. The list of organizational elements as modified is presented to the user is shown in the third screen of the user interface 620. The set of tuples of event elements can be presented in organizational elements that are added to the list. The list has been modified to include a set of tuples of event elements which all share the selected event element. As illustrated, all the listed organizational elements in the third screen of the user interface include the event element “San Bankman” as the subject.

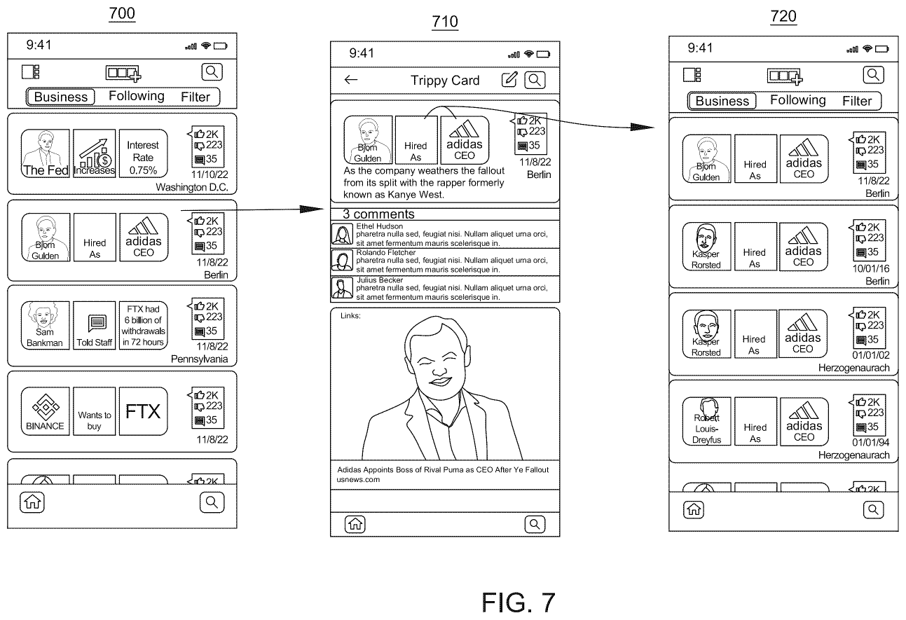

FIG. 7 illustrates a series of screens of a user interface for navigating an event-based knowledge graph via the selection of multiple event elements in accordance with specific embodiments of the inventions disclosed herein. The screens of the user interface shown in FIG. 7 can be part of the same user interface as was illustrated in FIG. 6. Accordingly, the first screen of the user interface 700 is presented in FIG. 7 and the selection of a different organizational element on the first screen of the user interface 700 leads to the fourth screen of the user interface 710 being presented in response to the selection. However, the input provided to the fourth screen of the user interface 710 is different in that both a first and a second user interface input element are selected such that they accept a selection of both a first and a second event element from a tuple of event elements. In response to this selection, a fifth screen of the user interface 720 is displayed which includes a modified list of organizational elements to include a set of tuples of event elements which all share both the first event element and the second event element. As illustrated, this allows for a quick search of all the CEOs of the company Adidas from a single organizational element regarding the new CEO of Adidas.

The screens can be presented and the lists can be modified in response to inputs to user interface elements in various ways. For example, upon the selection of an event element, a presented list may be modified using an animation to show organizational elements dropping out from the list and being replaced by new ones. This could involve moving directly from the first screen of the user interface 600 to the fifth screen of the user interface 720. The transition also may not involve the presentation of a new screen or page and may simply involve a change in the content displayed on a single screen or page of the user interface. As another example, upon selection of an event element, the selected event element may remain focused or highlighted after the modification of the list while the list held to be modified again upon the selection of a second event element. However, in a different example, upon selection of an event element via a first user input, the selected event element may draw focus or be highlighted before the list is modified and the user interface could hold for the selection of another event element before modifying the list or for a second user input indicating that selection of event elements was complete. For example, the first user input could be a press on a touch screen and the second user input could be a release of the press.

To efficiently retrieve and search through the database storing the event-based knowledge graphs, indexing services like Elasticsearch can be used. Text data can be indexed using natural language processing techniques to allow for full-text search capabilities, including vector search into an inverted index, such as Elasticsearch or OpenSearch. For images and other binary data, specialized indexes can be used that allow for image recognition and similarity searches. In specific embodiments, the user interface can include a search bar that sends queries, for example “George Washington” to the backend, the backend, could process these queries, interact with the indexing service, and return the relevant nodes and associated image and their relationships in the form of n-tuples, rendered in the user interface. Searching for one event element, “Sam Bankman” will return and display all events that share that event element. This can also be true if the search is for a combination of two or more tuples in an n-tuple event element.

The interaction of the user interface and the associated data processing systems that index, query, and develop the event-based knowledge graph can operate based on the following procedure. An interaction can begin with a user input in which a user interacts with the user interface by doing certain actions such as clicking a button, issuing a search, or making a request. The process can continue with a user interface event handler. When the user interacts with the user interface, an input user interface element (e.g., a button or input field) will trigger an event which is captured by the user interface framework or library being used (e.g., ReactNative). The process can continue with a user interface element modifying or maintaining a state. For example, a user interface element may maintain a state which represents the current data and user interactions within that component. For example, a search component might maintain the text search entered by the user. The process can continue with forming a request to communicate with the backend API. For example, a client device that instantiates the user interface can create an HTTP request which can involve specifying the HTTP method (e.g., GET, POST, PUT, DELETE), the API endpoint URL, request headers (e.g., authentication tokens, content type), and any request data (e.g., JSON payloads or query parameters) required for the request. The process can continue with making the request. The client device's framework/library can use a networking library or built-in functions to send the HTTP request to the backend API server. This could be done using technologies like Axios, Fetch API, or HTTP client libraries. The process continues with a step of interacting with the event-based knowledge graph. This can involve the backend API translating the user interface request into a GraphQL query, which it then sends to the database. The GraphQL query can specify the data requirements, including the fields, relationships, and filters needed to conduct the query. The event-based knowledge graph can then process the query, which typically involves traversing the graph to retrieve or manipulate the relevant data. The process can continue with a step of data processing. Once the graph database returns the results, the API may perform additional data processing or transformations, such as filtering, sorting, or aggregating data, before sending the response back to the user interface. The process may include caching or optimization. Caching mechanisms may improve performance by storing and serving frequently requested data from previous queries without hitting the graph database every time. The process may also include security and authorization processes. The API may enforce security and authorization rules to ensure that clients can only access data they are authorized to see. This can involve authentication checks and access control mechanisms. The API may also enforce rate limiting to prevent unauthorized attacks intended to steal the entire database. The process can continue with sending a response back to the client. The API can construct an HTTP response including an HTTP status code, response headers (e.g., content-type), and the response data. If successful, the data often includes the requested information or the result of an operation. The process can continue with user interface response handling. This can involve the client device receiving an HTTP response and extracting and processing the data from the response, typically in a format like JSON. The process can continue with updating the user interface based on the data received from the backend API. The user interface will then update its components and state. This may involve rendering new information or triggering further actions.

In specific embodiments, the organizational elements can utilize icons that are designed to both maximize their information content and minimize the time required for a person to determine the meaning of the icon. Specific event elements can be associated with an icon that is used every time that that specific event element appears in a tuple for the icon to be quickly recognized and understood. For example, an image of a badge could be used to indicate that someone was arrested, or an image of a gavel could be used to indicate that a judgement was levied in a case. As seen in the fifth screen of the user interface 720, the image can be text along as is shown by the “Hired as” icon, can be text and a logo as shown by the Adidas icon and “CEO”, and can be text and a picture as shown by the Bjorn Gulden icon.

In specific embodiments, a system can be provided to maximize the semiotic content of the icons. To this end the system can have access to data indicative of the time it took for a user to parse a displayed set of icons and find the icon they were interested in selecting. The system can also have the ability to change the icons for specific users to conduct A-B testing by applying specific icons to the user interface elements for specific events. The data can be obtained from an event listener in the system API that tracks the time between when an icon is loaded onto the screen and when it is selected. The system can keep track of how many different icons were presented on the screen at the same time and use that information to weight the perceived semiotic content of the icon. They system can attempt to balance semiotic distinctiveness towards icons that are used often and mute the semiotic distinctiveness of icons that are not used as often. In specific embodiments, the system can include an artificial intelligence system that can interpret the meaning and usage of specific event elements and select icons for testing or for permanent use that represent the desired meaning. The artificial intelligence system can be trained on data indicative of the time it took for a user to parse a displayed set of icons and find the icon they were interested in selecting.

### User Interface and Data Processing System for Pruning an Event

When creating and developing a crowdsourced system such as those described herein, it is inevitable that multiple users may contribute duplicate content that will result in the possibility of duplicate organizational elements or organizational elements that closely resemble each other to the extent that they could be considered synonyms. In these cases, these organizational elements will need to be deduplicated. Accordingly, systems in accordance with specific embodiments disclosed herein may include a graph pruning engine. The graph pruning engine can have features in accordance with graph pruning engine 305. The graph pruning engine can deduplicate the event-based knowledge graph by removing identical or synonymous event elements or organizational elements. The graph pruning engine can do this in an automated fashion using the approaches disclosed below. In specific embodiments, the graph pruning engine can also include a user interface that allows users to flag content as duplicative or to harvest information from the usage of the user interface for navigating the event-based knowledge graph to identify duplicative elements.

Deduplication in an event-based knowledge graph (such as one instantiated using RDF) can involve a multi-step process that involves normalization, the use of ontologies, the application of machine learning and NLP techniques, graph analysis algorithms, and sometimes manual intervention. These processes can ensure that the knowledge graph remains accurate, efficient, and semantically rich. Deduplication can involve identifying and resolving instances where the same information is represented more than once. This can occur when n-tuples are duplicated or when different n-tuples effectively represent the same thing (i.e., they are synonyms). Deduplication is crucial for maintaining the integrity and quality of data in the event-based knowledge graph.

To handle deduplication, the system can use various methods either alone or in combination. The methods can include URI canonicalization. URI canonicalization involves establishing a set of canonical URIs for entities and concepts to prevent multiple identifiers from referring to the same thing. When new data is ingested, the system would use these canonical URIs to ensure consistency. The methods can include equivalence statements. Equivalence statements can use RDF Schema (RDFS) or Web Ontology Language (OWL) to define equivalence between different nodes. For example, owl: sameAs can be used to state that two URI references actually refer to the same thing. The methods can include property constraints. Property constraints can involve using OWL to specify that certain properties should be unique for each entity (e.g., owl: InverseFunctionalProperty). This helps to identify different entities that actually refer to the same individual. The methods can include synonym resolution. In a synonym resolution process, synonyms are identified, often using a controlled vocabulary or an ontology, and then resolved to a single, preferred term. The methods can include machine learning and NLP techniques. The techniques can use machine learning models and natural language processing (NLP) to identify duplicates and synonyms based on context and content similarity. These techniques can compare literals, labels, and even textual descriptions to find potential matches. LLMs can be particularly useful here, as they have the ability to understand and generate human-like text, which can be leveraged to compare literals, labels, and textual descriptions for potential matches. The LLMs can process the natural language text associated with different nodes and properties in the knowledge graph, determining semantic similarity and flagging potential duplicates for further review or automatic deduplication. The methods can use graph-based deduplication algorithms. Graph-based algorithms look at the structure of the graph to identify potential duplicates. These algorithms consider not only the nodes and edges but also the shapes and patterns within the graph. The methods can use interactive deduplication. In some cases, especially when dealing with complex or ambiguous data, an automated system may not be sufficient. Here, a human-in-the-loop approach is used, where potential duplicates are flagged for review by a subject matter expert. The methods can use hashing techniques. The hashing techniques can generate hashes for events and event elements and compare them to efficiently identify exact duplicates. Since the same data will result in the same hash, this can be a fast method for finding duplicates. The methods can utilize merge policies. The merge policies can establish policies for how to handle duplicates once identified. This can involve merging nodes, combining properties, or selecting the most authoritative source as the ‘true’ node. The methods can utilize versioning and provenance. These approaches can keep track of the provenance and versioning of data to understand how events and event elements have been added to the graph over time, which can also help in identifying duplicates. The methods can also include continuous cleaning. Deduplication is not a one-time process and it can be conducted in an ongoing manner either continuously or periodically. As new data is added to the system, it should be continually checked against existing data for potential duplicates.

### User Interface and Data Processing System for Adding an Event

In specific embodiments of the invention, the system can be designed to assist users in contributing information to the system using the lexicography and syntax for which the event-based knowledge graph is designed. The platform can include an event definition engine for this purpose. In specific embodiments of the invention, the event definition engine allows for the definition of events and event elements subject to a set of constraints. The event definition can have the characteristics of event definition engine 306 from FIG. 3. The event definition engine can be instantiated by source code in the form of Python or Java and can use frameworks like Neo4j, Apache Jena, or RDFlib that support graph data structures and operations. The event definition engine can run on a server that has access to the event-based knowledge graph via an API. The event definition engine can work with the user interface to assist with the addition of events and event elements to the event-based knowledge graph to make sure that the constraints placed on the definition of events do not overly hinder the user experience flow of adding content to the event-based knowledge graph.

The event definition engine can include content creation wizards to guide users through the appropriate formation of an organizational element for a given event. The event definition engine can also utilize autofill and auto suggest systems that attempt to detect what event or event element a user is trying to add based on their input. These auto-suggest systems can be more advanced than the standard auto suggest systems found in search bars in that they can develop a semantic understanding of the content a user is attempting to add and generate a recommendation that completely alters the input as opposed to simply completing an existing sentence as input by the user.

The event definition engine can utilize similar approaches to process data harvested from other sources besides user inputs and convert them into event elements and events to add to the event-based knowledge graph. For example, the event definition engine could harvest data from online sources, develop a semantic understanding of the content of those sources, and produce events and event elements based thereon. The event definition engine could receive a uniform resource locator identifying a source of content, such as from a user interface in the form of a text box presented to a user, retrieve content from the source of content, generate a new event based on the content, generate content for a new content repository using the content, and associate the new content repository with the new event in the event-based knowledge graph.

The event definition engine can include content creation wizards that guide users through the appropriate formation of an organizational element for a given event. The content creation wizard may autosuggest event elements that match the language entered by the user. The suggestions can be provided so that event elements that are already part of the knowledge graph are used instead of creating duplicate entries. For example, a content-contributor trying to add an event element for Sam Bankman Fried, may be provided with the option to select an event element labeled “Sam Bankman” with an accompanying head shot picture. Such an approach would avoid the situation where multiple different event elements were added to the system which in fact represented a single underlying real world event element.

The content creation wizards can offer users varying levels of flexibility to provide their inputs. In specific embodiments, the wizards are tightly constraining and require users to provide single text inputs with respect to each individual event element that defines an event. In alternative embodiments, the wizards accept free form textual prose descriptions of events or mixed media descriptions such as text and images. In alternative embodiments, the wizards can accept recorded video descriptions of an event or an actual recorded video capture of the event. In specific embodiments, a large language model or other system may review the description of an event provided by a user, and automatically select the appropriate event elements for describing the event. For example, a content-contributing user could make a quick voice note saying “SBF has agreed to testify in front of the US House of Representatives” and the system could reformat that information into a tuple of event elements: “Sam Bankman”; “Aggress to Testify”; “U.S. House Hearing.” As another example, a content-contributing user could upload a video of Jerome Powell announcing an increase in the federal overnight funds rate and the system could reformat that information into a tuple of event elements: “The Fed”; “Raises”; “The Federal Funds Rate.”

In specific embodiments, the guided creation of event elements can assure that the knowledge graph does not have redundant entries and make sure that all the content associated with a given event ends up in the appropriate place. In specific embodiments, similar approaches can be utilized to deduplicate event elements and organizational elements that refer to the same underlying event by merging them into a single entry. In specific embodiments, similar approaches can be utilized to mine existing sources of information regarding events to build the knowledge graph automatically without the explicit assistance of content-creators using information that is already publicly available. For example, the event definition engine can utilize similar approaches to process data from free form entries by users to harvest from other sources besides user inputs and convert them into event elements and events to add to the event-based knowledge graph. For example, the harvested information could include video, audio, textual, and image data available on the Internet.

The process of creating and selecting n-tuples by the event definition engine can be done by a multi-model machine learning. The model may have been trained on data annotated by human experts or by other automatic processes. The model may follow a deep learning architecture, including by not limited to a perceptron, a recurrent neural network, a transformer, and a convolutional neural network. The model be trained to perform a variety of tasks, including but not limited to classification, generation, extraction and ranking. The model can be referred to as an n-tuple model.

The training set to train an n-tuple model consists of input content and output n-tuples, where n is an integer that is specific to that number of elements in the tuple. The input may be any piece of content, such articles, webpages, images, video, and audio files. The output/n-tuple may be a sequence of characters that represents the relationship between entities and other items/objects that may be present in the input content. The output sequence may be structured (e.g., JSON) or unstructured. The output may consist of a single n-tuple or a list of n-tuples. If the output is a list, then the list is ranked in terms of preference, from best matching to least matching. The output can be produced and edited by humans using a “dashboard”.

Training the n-tuple model can be conducted in various ways. The input content may be embedded into a sequence of real valued vectors, using various encoding methods. A training algorithm may take the embedded inputs and outputs from in training set and use it in an optimization procedure to minimize or maximize one or more target criteria. The result of the optimization procedure can be a trained model that is capable of selecting n-tuples from input content that is new (i.e., was not present in the training set when the model was trained). The pre-trained model may be further fine-tuned for specific tasks. Such tasks may be: (i) given an input, ranking n-tuples from best to worst; (ii) given an input and a n-tuple, produce a natural language description of that tuple; (iii) given two or more n-tuples, produce a degree of association between the n-tuples. The fine-tuning process may use further training datasets labeled by humans, in addition to the original training set that was used to pre-train the original model, for adaptation to the particular task. The fine-tuning of a pre-trained model may use optimization procedures that focus on individual tasks. Such procedure may be: (i) lightweight fine-tuning that freezes most of the pre-trained model's parameters and modifies the pretrained model with small trainable modules; (ii) introducing task-specific layers between the layers of the pre-trained model; (iii) pre-fix tuning; and (iv) low rank adapters (LoRA).

The model can perform inferences on new input content by taking in the input content that may or may not have previously been used in the training set and producing n-tuples as an output. During inference the n-tuple model may be prompted to perform various tasks. The prompt can specify the task. For example, the task may be to return a single 3-tuple (i.e., a triplet) or to first, create a list of candidate n-tuples and then rank them from best to worst, in terms of how well they represent the input content.

In specific embodiments of the invention, the n-tuple model can be optimized using various in-context learning methods. A set of examples of in-context learning techniques that may be used include: (i) sequential and iterative prompting; (ii) chain-of-thought prompting; (iii) tree of thoughts; (iv) generated knowledge prompting; and (v) step-back prompting.

In specific embodiments of the invention, upon generation of an organizational element, a content-contributing user will need to identify each event element in the organizational element. The user will use a search bar to type the term for the first event element, and this process will both auto-complete the term when possible, and automatically suggest the most likely images associated with that organizational element. As stated previously, this process can be conducted in a manner that suggests icons with a high degree of semiotic distinctiveness. In specific embodiments, certain event elements can be assigned an icon with a lower degree of semiotic distinctiveness depending upon how often the event element is expected to be used, using the following technical components and steps. The user interface can include a search bar to capture user input in real-time. The user interface can be built using responsive web technologies such as HTML, CSS, and JavaScript frameworks like React or Vue.js. As the user types, an event listener in the front-end sends the input text to the backend server using AJAX or WebSocket for a more real-time interaction. The backend API service can receive the user input from the user interface. An API endpoint can process the input text and interact with the search and suggestion system. The system can include a search and suggestion system. The search system quickly generates suggestions based on the partial input received. This system would use an optimized index, possibly within a tool like Elasticsearch, which can handle partial matches and auto-complete functionality. The system can have a pre-built index of terms and associated images, perhaps created using metadata, tags, and textual descriptions of images that are extracted and stored during an initial indexing phase. The system can utilize image databases and indexing. The images can be stored in a database with associated metadata including tags and descriptions. When indexing these images the system can perform feature extraction using computer vision techniques to enable content-based image retrieval. The system can use autocomplete logic. The backend can use an autocomplete algorithm that uses the partial input to predict a full search term. This could be implemented with tree data structures, fuzzy search algorithms, or machine learning models. NLP can be used to rank the predicted terms based on the likelihood of their relevance to the partial input. The system can include real-time image retrieval. Upon determining the most likely search terms, the backend queries the image database for the top images associated with these terms. The system can implement caching strategies for common terms to speed up the retrieval process. The system can include front end display logic. Using React, the user interface will dynamically update as new data is received without the need to reload the page. The user interface can present the images in a user-friendly format, such as a grid or list, next to or below the search bar, updating as the user continues to type. By combining these components, the system can present image suggestions in real-time as the user types into the search bar, enhancing the user experience by providing immediate visual feedback.

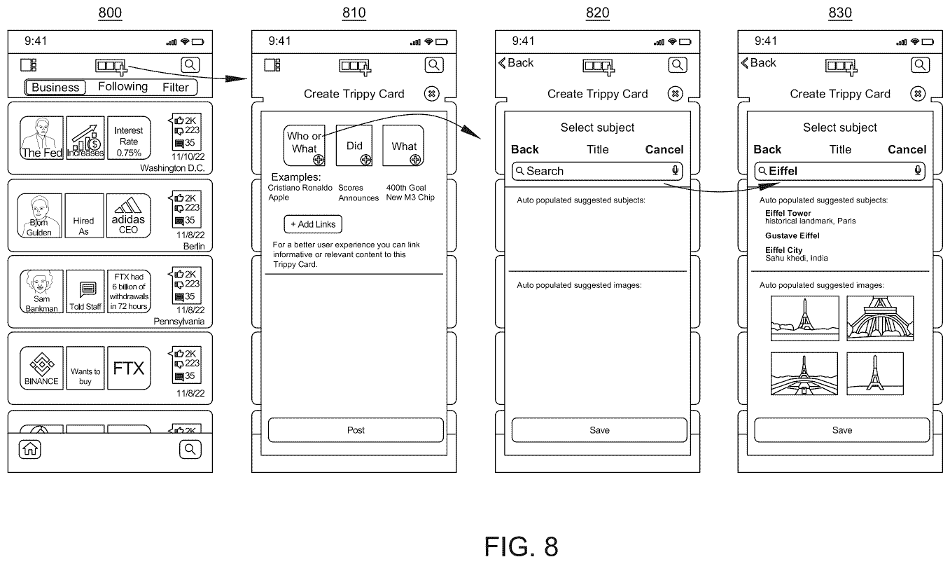

FIG. 8 illustrates a series of screens of a user interface for adding to an event-based knowledge graph in accordance with specific embodiments of the inventions disclosed herein. The figures provide an example of a set of screens for a wizard that can be provided by an event definition engine to assist a user in defining an event. As seen in screen 800, a user is able to select a user interface element indicating that a user is interested in defining an event for addition to the event-based knowledge graph. In response to the selection of this icon, a second screen 810 is provided, which provides inputs for three event elements. The user interface elements are provided with examples of the types of things that should be added using each of the interface elements. While in this example a set of three user interface elements are provided, more or less elements can be provided based on the number of event elements that are used to define an event. As illustrated, the user interface elements prompt a user to add a subject, predicate, and direct object to describe the event. Upon selection of the user interface elements, the user interface changes to a screen which allows a user to define the content for the specific event element to be added.

FIG. 8 further illustrates additional screens displayed through the process of adding to an event-based knowledge graph. As seen in screen 820, a user is able to select a search bar to define the event element for the event. The search bar can operate using the principles described above and can be designed to make the user experience enjoyable while at the same time minimizing or eliminating the creation of duplicate event elements. As seen in screen 830, the user has begun to enter the name of the subject “Eiffel tower,” and the suggestion system has presented images of the Eiffel tower along with alternative potential matches for the user input. At this point, the user can then select the event element from the list that matches their intent and then hit the save button at the bottom to lock in their selection. The user would then be returned to a version of screen 810 with one of the event elements filled in order to reflect their decision. Using this intuitive process, a user can quickly define an event by looping through the process for each of the elements. In situations in which the event element is not already in the database of the system and cannot be accessed via the Internet, a user can instead add their own custom images and text in order to define the event element.

In specific embodiments, the user interface for adding to an event-based knowledge graph can include a user interface where a link to an external source of content can be provided to the system. The user interface can be a text box for a uniform resource locator to where the content is located. In response to the entry of data at the link, the system can retrieve the content located at that link and automatically convert it into events and content for the system. The user interface may include an additional set of fields that appear if user credentials are required to access the content. The user interface may include additional fields or wizard interfaces that appear in order to allow the user to define or approve portions of the external data to onboard into the system and to have input into how the associated events are defined.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to organizational elements with a triple of event elements of subject, predicate, direct object format, the same approaches could be utilized for event-based knowledge graphs with organizational elements having n-tuples of event elements with of various different types and combinations. These and other modifications and variations to the present invention may be practiced by those skilled in the art, without departing from the scope of the present invention, which is more particularly set forth in the appended claims.

What is claimed is:

1. A system comprising:
an event-based knowledge graph wherein:
the event-based knowledge graph comprises a set of nodes and a set of edges; and
the set of nodes and the set of edges represent a set of event elements and connections within the set of event elements;
a set of dedicated content repositories for a set of events wherein:
the set of events are associated with the set of event elements; and
a user interface, comprising a set of user interface elements wherein;
the set of user interface elements are associated with the set of event elements; and
the set of user interface elements provide navigation to dedicated content repositories in the set of dedicated content repositories for events in the set of events that are associated with a same event element from the set of event elements.

2. The system of claim 1, further comprising:
an event definition engine, wherein the event definition engine causes the user interface to accept a definition of nodes in the set of nodes and edges in the set of edges subject to a set of constraints;
wherein the set of constraints require an event to be defined by a fixed number of event elements.

3. The system of claim 2, wherein:
the set of constraints requires an event to be defined by a set of event elements having specific types.

4. The system of claim 1, further comprising:
a graph pruning engine, wherein the graph pruning engine modifies associations between the set of dedicated content repositories and the set of events.

5. The system of claim 1, wherein:
a second set of nodes represents the set of events; and
the set of edges connect the set of nodes to the second set of nodes to represent associations between the set of events and the set of event elements.

6. The system of claim 5, wherein the set of nodes and the set of edges represent the set of event elements and connections within the set of event elements in that:
the set of nodes represents the set of event elements; and
the set of edges represents connections within the set of event elements.

7. The system of claim 1, wherein the set of nodes and the set of edges represent the set of event elements and connections within the set of event elements in that:
the set of nodes represents the set of event elements; and
the set of edges is a set of hypergraph event edges and represent both: (i) connections within the set of event elements; and (ii) the set of events.

8. The system of claim 1, wherein:
the set of event elements includes a set of parent event elements and at least one set of child event elements;
the event-based knowledge graph represents connections between the set of parent event elements and the at least one set of child event elements;
the set of events includes a subset of events that are associated with the at least one set of child event elements; and
the set of user interface elements includes a set of parent event element user interface elements that provide navigation to dedicated content repositories in the set of dedicated content repositories associated with the subset of events.

9. A system comprising:
a list of organizational elements, wherein each organizational element comprises a tuple of event elements; and
a user interface input element that accepts a selection of an event element from the tuple of event elements;
wherein the list of organizational elements is modified, in response to the selection of the event element, to include a set of tuples of event elements which all share the event element.

10. The system of claim 9, further comprising:
a second user interface input element that accepts a selection of a second event element from the tuple of event elements;
wherein the list of organizational elements is modified, in response to the selection of the second event element, to include a set of tuples of event elements which all share the event element and the second event element.

11. The system of claim 9, wherein:
the tuple of event elements includes a direct object event element, a verb event element, and a subject event element;
the user interface input element is a card representing an event element in the tuple of event elements; and
an organizational element in the list of organizational elements comprises a triplet of cards including the card.

12. A system comprising:
an event-based knowledge graph for a set of events;
an event definition engine, wherein the event definition engine allows for a definition of a new event for the event-based knowledge graph subject to a set of constraints, and wherein the set of constraints includes a constraint that an event be associated with a tuple of event elements having a fixed number of elements; and
a graph pruning engine, wherein the graph pruning engine deduplicates, in a deduplication, duplicate events from the event-based knowledge graph that refer to a single real-world event.

13. The system of claim 12, further comprising:
a user interface;
wherein the event definition engine requires one of: (i) the constraints in the set of constraints to be met manually from inputs on the user interface; and (ii) an identification of a source of content using the user interface and the constraints in the set of constraints to be met automatically by the event definition engine.

14. The system of claim 13, wherein:
the user interface is a text box for a uniform resource locator; and
the event definition engine: (i) retrieves content from the source of content; (ii) generates the new event based on the content; (iii) generates second content for a new content repository using the content; and (iv) associates the new content repository with the new event in the event-based knowledge graph.

15. The system of claim 12, further comprising:
a user interface;
wherein the graph pruning engine uses feedback from the user interface for the deduplication of events.

16. The system of claim 12, further comprising:
a large language model;
wherein the graph pruning engine uses the large language model for the deduplication of events.

17. The system of claim 16, wherein:
the set of events in the knowledge graph are associated with a set of content repositories;
the graph pruning engine is configured to generate a set of embedding vectors for the set of events using the set of content repositories;
the graph pruning engine includes a retrieval system configured to retrieve related content from at least two content repositories in the set of content repositories that are associated with at least two events using the set of embedding vectors; and
the large language model uses the related content to generate a determination that the at least two events are duplicates using the content.

18. The system of claim 16, wherein:
the set of events in the knowledge graph are associated with a set of content repositories;
the graph pruning engine is configured to generate a set of embedding vectors for the set of events using the set of content repositories;
the graph pruning engine includes a retrieval system configured to retrieve related content from at least two content repositories in the set of content repositories that are associated with at least two events using the set of embedding vectors; and
the large language model uses the related content to generate a canonical summary of the related content to store in a single content repository.

19. A system comprising:
a user interface;
a list of organizational elements presented on the user interface, wherein the organizational elements in the list of organizational elements comprise tuples of event elements, wherein the event elements appear in multiple tuples of event elements in the list of organizational elements; and
a set of unique icons associated with the event elements in a one-to-one correspondence, wherein the unique icons in the set of unique icons are presented in the event elements in the tuples of event elements.

20. The system of claim 19, further comprising:
a neural network that accepts a description of an event and a set of information associated with the set of unique icons and that outputs a unique icon for the event;
wherein the neural network is trained to maximize a semiotic distinctiveness of the unique icon with respect to the event.
